(19) United States
(12) Patent Application Publication
(10) Pub. No.: US 2013/0233141 A1
(43) Pub. Date: Sep. 12, 2013

(54) APPARATUS AND METHOD FOR CUTTING FOOD ITEMS

(71) Applicants: Ronald Eugene Hunt, Georgetown, TX (US); Donnie Lee Miller, Austin, TX (US); Verlon Eugene Whitehead, Austin, TX (US)

(72) Inventors: Ronald Eugene Hunt, Georgetown, TX (US); Donnie Lee Miller, Austin, TX (US); Verlon Eugene Whitehead, Austin, TX (US)

(73) Assignee: CD3 HOLDINGS, INC., Austin, TX (US)

(21) Appl. No.: 13/417,099

(22) Filed: Mar. 9, 2012

(51) Int. Cl. B26D 1/09; A47J 43/00; B26D 7/18

(52) U.S. Cl. 83/167; 83/856; 83/699.51

(57) ABSTRACT

An apparatus for cutting food items includes a base having an opening and being configured to support one or more blade inserts in the opening. At least one guide is coupled to the base and is configured to accommodate first and second telescoping members, the first telescoping member being nested within the guide, the second telescoping member being nested within the first telescoping member and the first and second telescoping member being slidably movable in a reciprocating manner along an axis relative to the base. A compression member is coupled to the first telescoping member and movable to a first maximum distance from the top portion of the base. A striking member has a weight sufficient to impart a concussive force on the compression member and is coupled to the second telescoping member and movable to a second maximum distance from the compression member.

### FIELD OF THE INVENTION

The present invention relates to an apparatus and method for cutting food items and, more particularly, an apparatus and method that permits the selective slicing, dicing and chopping of various food items.

### BACKGROUND

Culinary prep work represents the most labor-intensive and the most important stage of cooking and inevitably requires the cutting, chopping, slicing, and dicing of food items into a variety of proportions. While there exists a variety of devices that simplify the task, a different challenge is often presented with dense or fibrous food items, as such items are more difficult to cut. Oftentimes, the problem is that insufficient compressive force is applied to effectuate the cutting. A need therefore exists for an improved apparatus for cutting dense or fibrous food items into a variety of different shapes.

### SUMMARY OF THE INVENTION

The present disclosure provides an apparatus and method by which dense and fibrous food items may effectively be cut in a number of different configurations (slice, dice, chop, etc.) through simultaneous application of concussive impact and compressive forces onto a food item placed in contact with a plurality of blades.

In accordance with one preferred embodiment, an apparatus for cutting food items comprises a base, a striking member movably disposed above the plurality of blades, and a compression member movably disposed between the plurality of blades and the striking member. The base supports a plurality of blades. Both the compression and striking members are movable in opposing directions along an axis of travel.

In accordance with a first aspect of the preferred embodiment, the apparatus further comprises a collection bin that is configured to be removably placed below the plurality of blades.

In accordance with a second aspect of the preferred embodiment, the striking member has a weight that is greater than a weight of the compression member.

In accordance with a third aspect of the preferred embodiment, the striking member comprises a weighted plate disposed within a casing.

In accordance with a fourth aspect of the preferred embodiment, a top surface of the casing comprises a shock absorbing material.

In accordance with a fifth aspect of the preferred embodiment, the compression member further comprises a pusher plate comprising a plurality of projections, the pusher plate being aligned along the axis with the plurality of blades configured to support the food item placed between the pusher plate and the plurality of blades.

In accordance with a sixth aspect of the preferred embodiment, the plurality of blades includes a first set of parallel blades and a second set of parallel blades, the first and second set of parallel blades being rotatably positioned within the base.

In accordance with a seventh aspect of the preferred embodiment, the apparatus further comprises a first support member and a second support member. The first support member is coupled to the compression member and at least partially disposed within the base to slidably move the compression member relative to the base. The second support member is coupled to the striking member and is at least partially disposed within first support member to slidably move the striking member relative to the compression member and the base.

In accordance with an eighth aspect of the preferred embodiment, the first member and second member may be configured as tubes with the first member being configured to nest within the second member. Upward motion of the first and second members may be limited by stops.

In accordance with another preferred embodiment, an apparatus for slicing and/or dicing food items comprises a base, at least one guide coupled to the base, a compression member, and a striking member. The base comprises a top portion spaced above the ground, the top portion including an opening and being configured to support a plurality of blades in the opening. The at least one guide is configured to accommodate first and second telescoping members, the first telescoping member being nested within the guide, the second telescoping member being nested within the first telescoping member and the first and second telescoping member being slidably movable along an axis relative to the base. The compression member is coupled to the first telescoping member and is movable to a first maximum distance away from the top portion of the base. The striking member is coupled to the second telescoping member and is movable to a second maximum distance away from the top portion of the base.

In accordance with a first aspect of the preferred embodiment, the at least one guide and the first and second telescoping members are cylindrical tubes.

In accordance with a second aspect of the preferred embodiment, the at least one guide and the first and second telescoping tubes each have abutting stops to set the first and second maximum distances.

In accordance with a third aspect of the preferred embodiment, the plurality of blades is provided by one or more blade inserts.

In accordance with a fourth aspect of the preferred embodiment, the one or more blade inserts may be rotatably positioned relative to one another in the opening.

In accordance with a fifth aspect of the preferred embodiment, the blade inserts comprise tensioned blades and a die cast metal frame.

In accordance with a sixth aspect of the preferred embodiment, the blade inserts may be positioned in the opening by mating alignment guides and tabs.

In accordance with a seventh aspect of the preferred embodiment, the apparatus further comprises a collection bin having an internal cavity. The collection bin may be removably disposed below the top portion of the base and dimensioned to accommodate at least the base, compression member and the striking member within the internal cavity.

In accordance with an eighth aspect of the preferred embodiment, the weight of the striking member is from 0.5 to 5 lbs.

In accordance with a ninth aspect of the preferred embodiment, the apparatus further comprises a pair of suction cups disposed diagonally on opposing sides of the base to secure the apparatus to a surface.

In accordance with a further preferred embodiment, an apparatus for cutting food items comprises a base comprising a top portion spaced above the ground, the top portion including an opening and being configured to support one or more blade inserts in the opening, the one or more blade inserts each comprising one or more blades. At least one guide is coupled to the base, the guide being configured to accommodate first and second telescoping members. The first telescoping member is configured to be nested within the guide, the second telescoping member is configured to be nested within the first telescoping member.

The first and second telescoping members are slidably movable in a reciprocating manner along an axis relative to the base. A compression member is coupled to the first telescoping member and movable to a first maximum distance from the top portion of the base. The compression member further comprises a pusher plate to support the food item placed between the compression member and the blade inserts disposed in the opening of the top portion of the base. A striking member has a weight sufficient to impart a concussive force on the compression member, the striking member being coupled to the second telescoping member and movable to a second maximum distance from the compression member. A bin is removably disposed below the opening configured to receive cut food items as it exits the opening having the one or more blade inserts.

Other objects, features and advantages of the present invention will become apparent to those skilled in the art from the following detailed description.

### BRIEF DESCRIPTION OF THE DRAWINGS

These and other features and advantages of the present invention will be appreciated as the same becomes better understood by reference to the following detailed description when considered in connection with the accompanying drawings wherein:

FIG. 1 is a perspective view of the cutting apparatus with a food item positioned for cutting and the striking member positioned for deployment;

FIG. 2 is a perspective view of the cutting apparatus showing the striking member after it has been deployed to deliver a concussive force to the compression member;

FIG. 3 is an exploded perspective view of an embodiment of the cutting apparatus;

FIG. 4 is an exploded perspective view of a partially assembled embodiment of the cutting apparatus;

FIG. 5 is an exploded perspective view of a portion of the base assembly;

FIG. 6 is a perspective view of the cutting apparatus being positioned within the bin for storage;

FIG. 7 is a perspective view of the cutting apparatus with the bin being positioned for collection of cut food items;

FIG. 8 is an exploded perspective view of the collection bin;

FIG. 9A is a side view of the cutting apparatus in a collapsed state; and

FIG. 9B is a cross-sectional view of the cutting apparatus in a collapsed state; and Like numerals refer to like parts throughout the several views of the drawings.

### DETAILED DESCRIPTION

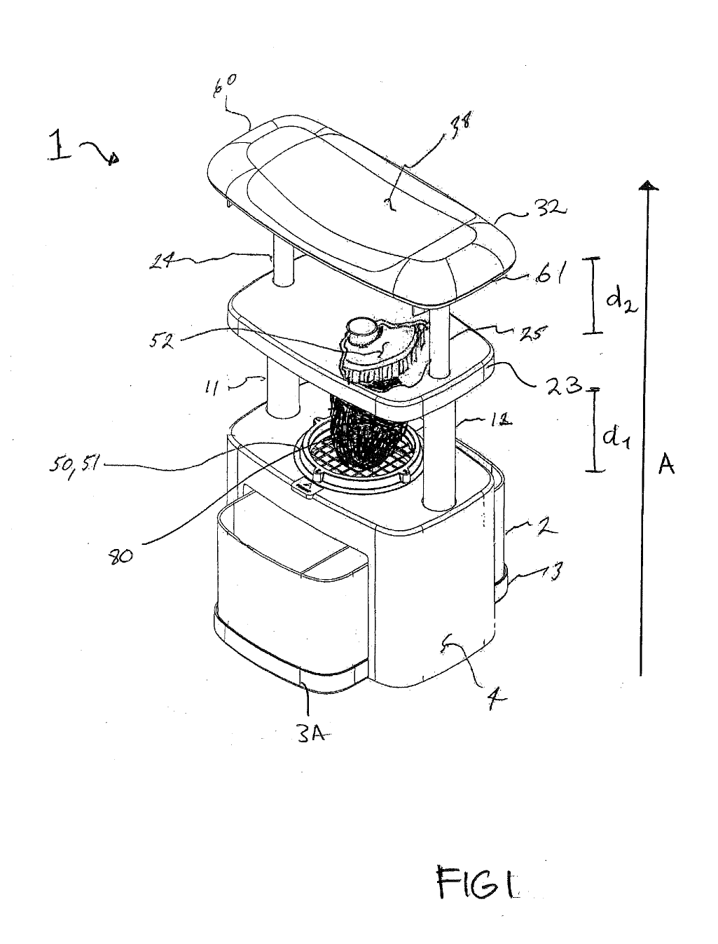

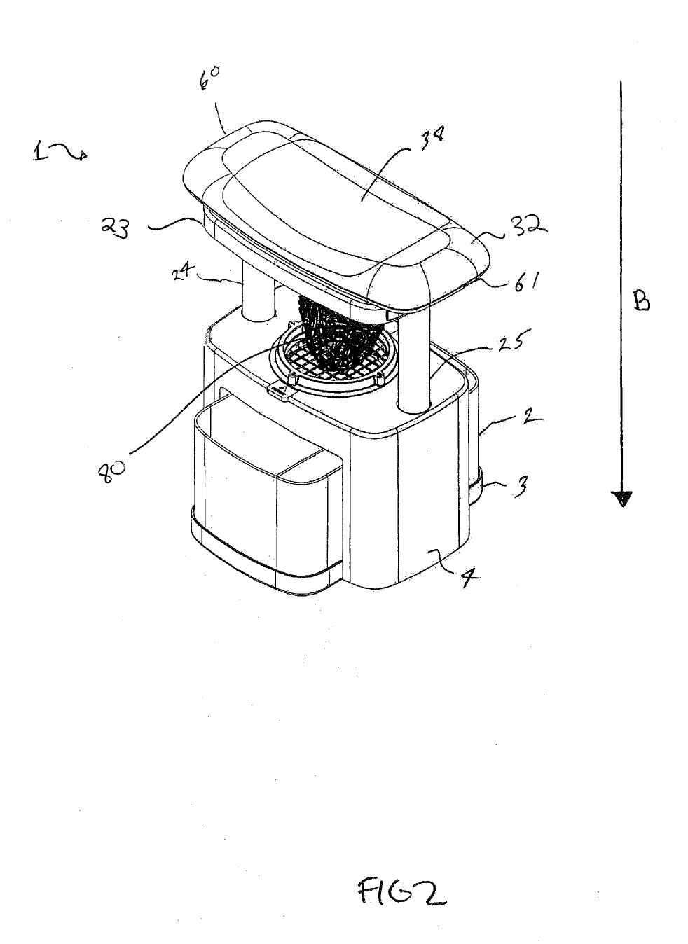

FIGS. 1 and 2 show the operation of an embodiment of the food cutting apparatus 1 with respect to a food item 80 placed thereon to be cut. The food cutting apparatus 1 comprises generally of a base 4, a compression member 23 and a striking member 38. The base 4 is configured to be positioned on a planar support surface, such as a table or countertop, and the compression member 23 and the striking member 38 are configured to be movably disposed relative to the base and also to one another in a reciprocating manner along an axis of travel along A and B as indicated in FIGS. 1 and 2, respectively.

The operation of the apparatus 1 will now generally be described, followed by a description of the specific components constituting the apparatus 1.

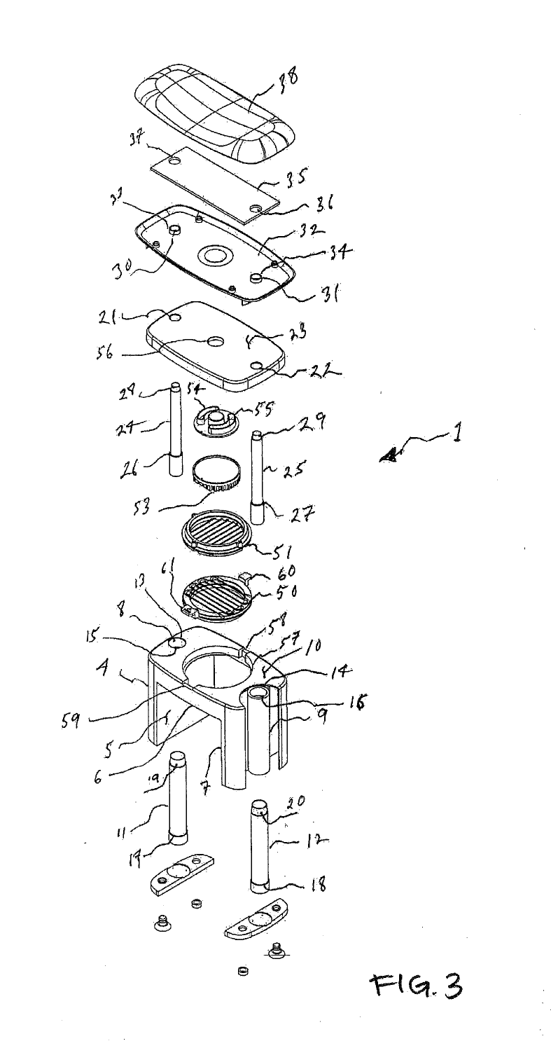

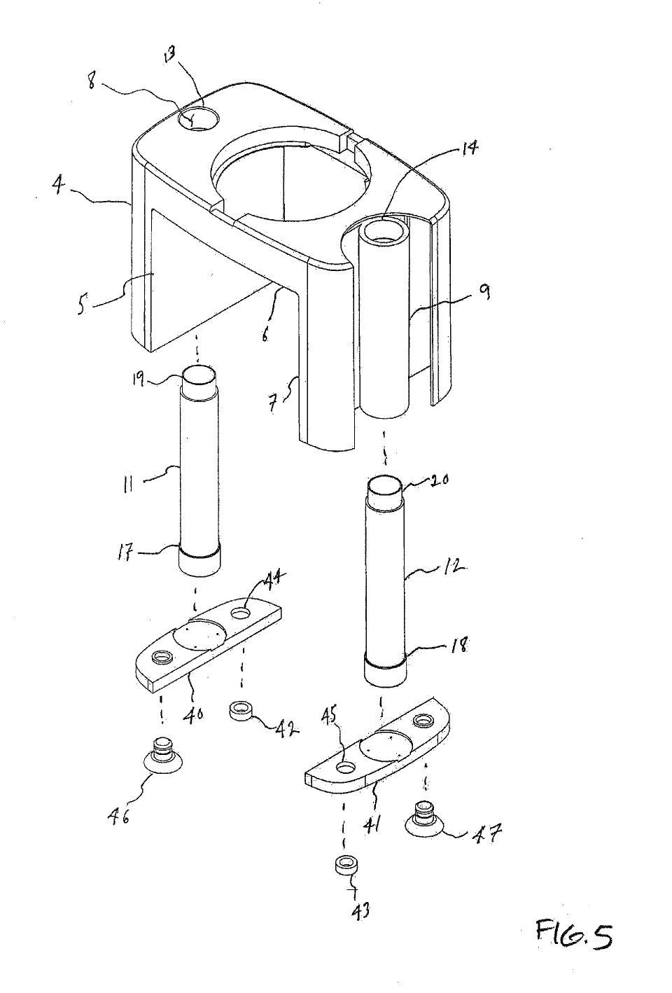

As shown in FIG. 1, the compression member 23 and the striking member 38 are raised in a direction as indicated by A to a fully expanded position to allow loading of a food item 80 to be cut. As discussed in more detail below with respect to FIGS. 3-5, first telescoping members 11, 12 and second telescoping members 24, 25 are coupled to the compression member 23 and striking member 32, respectively, in a manner that permits full expansion of the apparatus by grasping and raising the striking member 32 in direction A away from the base 4.

Once the apparatus 1 is fully expanded, as shown in FIG. 1, a food item, such as a potato 80, may be positioned between the base 4 and the compression member 23. The compression member 23 preferably further comprises a pusher plate 52 to support and stabilize the food item 80 as it is pushed through the plurality of blades disposed on the base. In a preferred embodiment, the food item 80 is positioned in the center of the plurality of blades as shown in FIGS. 1 and 2.

Starting at the position shown in FIG. 1, a user's hand grasps the striking member 32 at the two ends 60, 61 and exerts a downward force applied to the striking member 32 to impact the compression member 23 in the direction of B shown in FIG. 2 to provide an initial impulse necessary to force the food item 80 into the plurality of blades disposed on the base 4. This motion may be repeated by raising the striking member 32 and again exerting a downward force applied to the striking member 32 to impact the compression member 23 until the cutting of the food item 80 is sufficiently initiated to allow continued cutting of the food by application of compressive forces of the striking member 32 in contact with the compression member.

This method of cutting is to be distinguished from cutting that is accomplished by the application of mere compressive forces. With many food items, compression is sufficient to effectuate the cutting; however, for dense and fibrous foods, mere compression is not sufficient and requires the initiation of an impulse force. The striking member 32 is thus significant in that it provides the impulse force necessary for the initiation of the cutting which may be repeated to force the food item through the plurality of blades.

The extent of the impulse force applied by the striking member 32 depends on the weight of the striking member 32 and the speed and distance traveled by the striking member 32 and thus may be varied depending on the particular food items the apparatus is intended to cut. The greater the weight of the striking member 32 and the greater the speed and the distance (d2) traveled by the striking member, the greater the impulse force applied to the compression member 23 and thus the food item 80.

Turning now to the components comprising the cutting apparatus, reference is made to FIGS. 1-5.

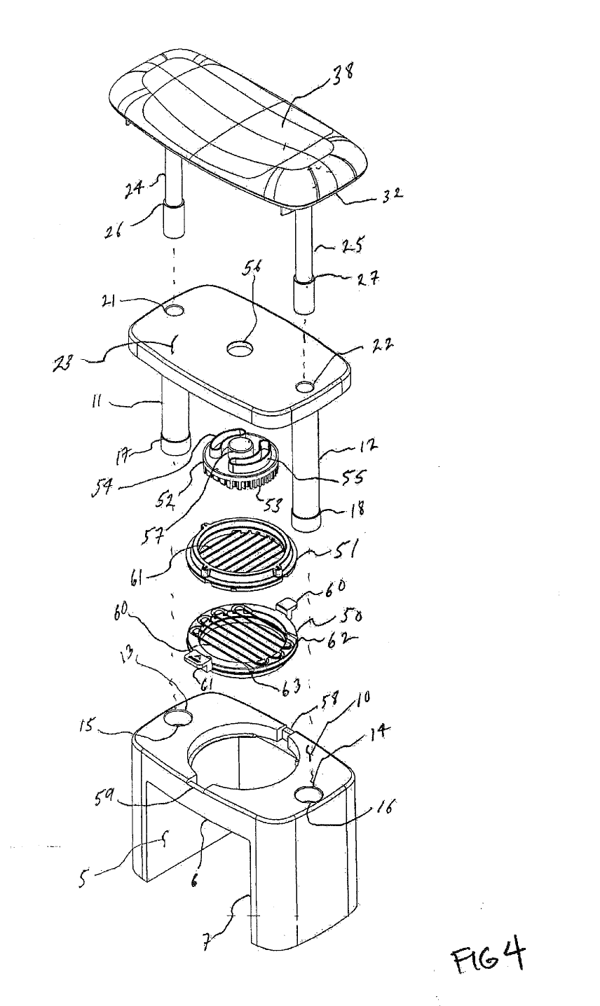

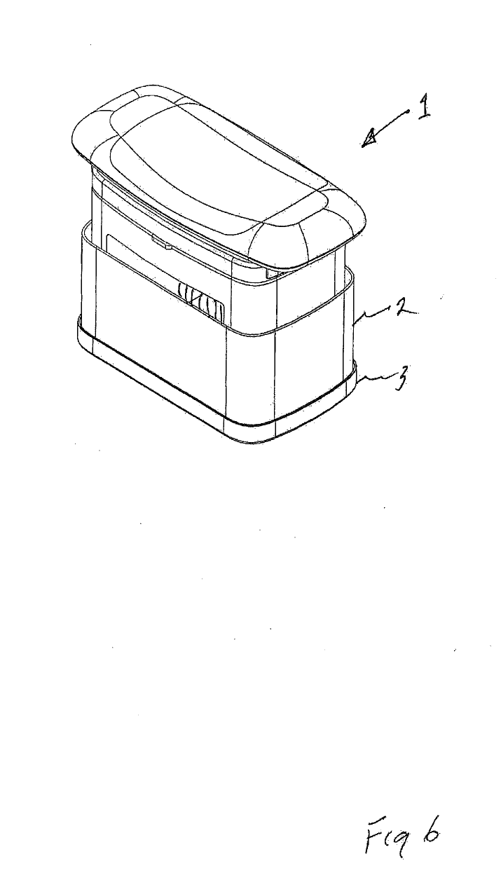

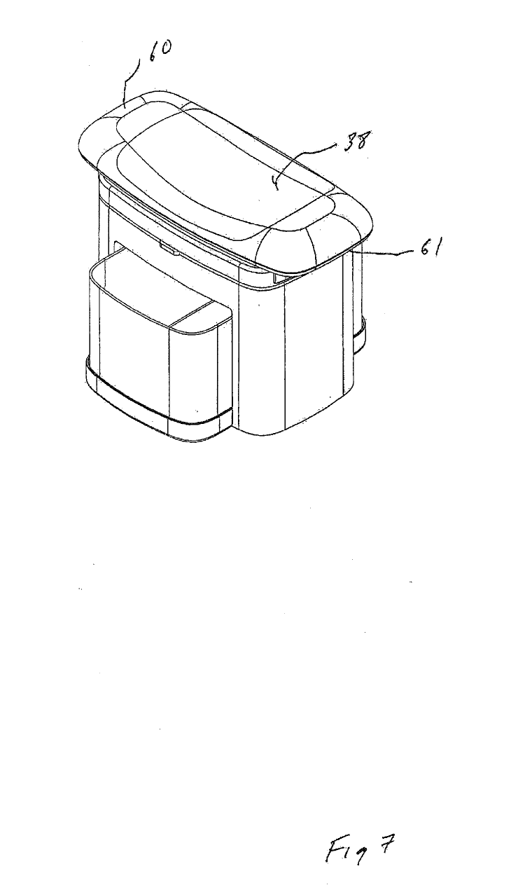

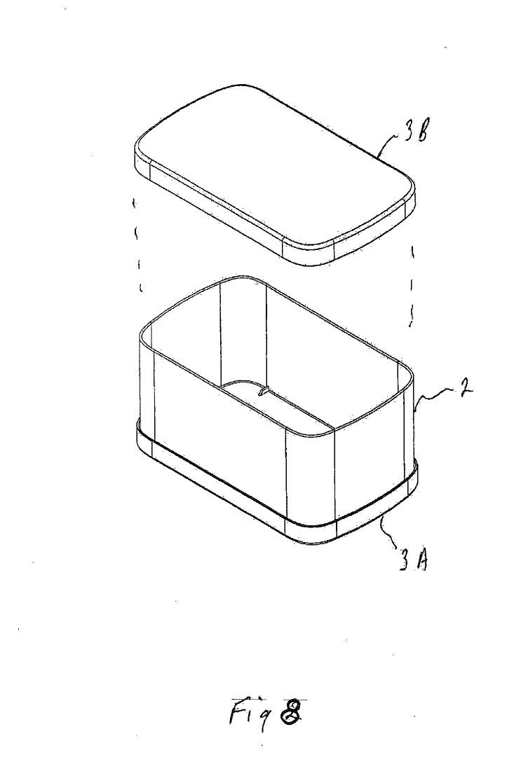

The base 4 comprises a plurality of blades removably disposed within an opening on the top surface of the base 4. In a preferred embodiment, the base 4 is configured to position the plurality of blades a distance above a support surface on which it rests. This permits a collection bin 2 to be disposed below the plurality of blades to collect the cut food items after it passes through the plurality of blades. The collection bin 2 is preferably removably positioned within a space defined by the walls 5, 6, 7 of the base shown in FIG. 4. The collection bin 2 is further depicted in FIG. 8 as including a lid 3 which is positionable either on the bottom surface 3A to provide a non-slip grip positioned in the base 4 and during cutting operations or on the top 3B to provide a food storage container. FIGS. 1, 2, 6 and 7 show the collection bin 2 with the lid positioned on the bottom surface 3A.

The plurality of blades is depicted in FIGS. 3 and 4 as a first and second blade cutter ring 50, 51, each of which comprise a frame and a plurality of tensioned parallel blades. In a preferred embodiment, the frame is made of die cast metal to withstanding impact loading and slicing of the food items therethrough.

The first blade cutter ring 50 may preferably further comprise aligning tabs 60, 61 disposed on opposing sides of the frame. The aligning tabs 60, 61 are configured to mate with corresponding alignment slots 58, 59 disposed on the top surface of the base 4, preferably near the opening in which the first blade cutter ring 50 is to be positioned. The use of only the first blade cutter rings 50 in the cutting apparatus will permit the slicing of food items in predetermined widths roughly corresponding to the distance between the plurality of blades of the blade cutting rings 50. Thus, in a preferred embodiment, the apparatus 1 is provided with a plurality of blade cutter rings having various distances between the plurality of blades so that food items may be cut in a range of thicknesses.

A second blade cutter ring 51 may further be provided. The second set of the blade cutter rings 51 may be especially adapted for use in combination with the first blade cutter rings 50 and may similarly be provided in a range of width with respect to the blades as described above. The second blade cutting rings 51 may thus be configured to be stacked on top of the first blade cutting ring 50 and may further include alignment tabs to fix the position of the second blade cutter rings 51 in relation to either one or both of the first set of blade cutter rings 50 or the base 4.

In a preferred embodiment, the second blade cutting rings 51 is rotatable, such that the plurality of blades in the first blade cutter ring 50 and the plurality of blades in the second blade cutter ring 51 define an angle. Thus, where it is desired to dice a food item, the first and second blade cutting rings 50, 51 are positioned such that the plurality of blades define a 90 degree angle, as shown in FIGS. 1-4.

The compression member 23 is disposed between the base 4 and the striking member 32. The significance of this arrangement will become apparent in view of the respective features and functions of the compression member 23 and the striking member 32. The compression member 23 generally comprises a plate-like structure having a top surface facing the striking member 32 and a bottom surface facing the plurality of blades on the top surface of the base 4. The bottom surface of the compression member 23 preferably comprises a further structure which permits food items to be gripped and stabilized during the cutting process.

In one preferred embodiment, a pusher plate 52 is provided to removably attach to the bottom surface of the compression member 23. The pusher plate 52 is shown in greater detail in FIGS. 3-4. On the side facing the compression member 23, the pusher plate 52 comprises a cylindrical tenon 57 that is configured to snap into a corresponding hole 56 on the compression member 23. Pusher plate 52 also comprises protruding arch segments 54, 55 which further mate with female arch segments (not shown) on the compression member 23 to rotationally stabilize the pusher plate 52. On the side facing the base, the pusher plate 52 comprises a plurality of fingers 53 to support a food item that is placed between the compression member 23 and the plurality of blades. The apparatus 1 is configured such that the plurality of fingers 53 do not make contact with the plurality of blades when the compression member 23 is pushed completely toward the base 4 in the direction shown in FIG. 2.

The striking member 32 is disposed above the compression member 23 and is depicted in FIGS. 1-4 and 6-7. The striking member 32 comprises a top surface 38 which is shaped and ergonomically configured to be handled by a user. In a preferred embodiment, the top surface 38 is made of a shock-absorbing material, such as molded rubber-like material. The striking member 32 may either itself be weighted or further comprise a weighted member 35 enclosed within the top surface 38 and the lower plate 32. In a preferred embodiment, the striking member 32 or the weighted member 35 has a weight in the range of 0.5 to 5 lbs, preferably 1 to 3 lbs, and most preferably 1.5 to 2 lbs.

The distance dl between the top surface of the base 4 and the compression plate 23 is largely dictated by the size of the food item for which the cutting apparatus 1 is intended. The distance d2 between the compression plate 23 and the striking plate 32 is largely dictated by the amount of force that is desired to be applied to the compression plate 23 and thus to the food item 80 placed between the compression plate 23 and the plurality of blades. In a preferred embodiment, d2 is 3 inches or more, preferably 3.5 inches, and more preferably 4 inches.

Turning now to the assembly of the apparatus 1, reference is again made with respect to FIGS. 1-4. In FIG. 1, the base 4 is depicted as comprising two molded hollow tubes 8, 9. The inner diameter of the tubes 8, 9 form holes 13, 14 in the top surface 10 of the base 4. Inside tubes 8,9, and approximately one inch below the top surface 10, the diameter of the tubes 8,9 increase forming shoulders 15, 16.

A first pair of telescoping members comprising hollow tubes 11, 12 comprise shoulders 15, 16 and are inserted upwardly from the bottom of the hollow tubes 8,9 until the shoulders 17, 18 abut the shoulders 15,16 inside tubes 8,9. The top of tubes 11, 12 are coupled to the compression member 23 and thus the length of the hollow tubes 11, 12 and the location of the shoulders 17, 18 may be varied to determine the d2 length desired between the compression member 23 and the plurality of blades.

The outer diameter at the top of the first pair of telescoping members 11, 12 have been stepped down to form cylindrical tenons 19, 20 which is inserted into bores 21, 22 disposed in the compression member 23. In a preferred embodiment, tubes 11, 12 are bonded to the compression member 23 by ultrasonic or chemical means. Once assembled, the compression frame 23 may be raised and lowered over a height d2 with respect to the base 4. In a preferred embodiment, d2 is 4 inches or more.

A second pair of telescoping members 24, 25 is inserted upwardly from the bottom of the base 4 and inside the first pair of telescoping members 11, 12, respectively. The second pair of telescoping members 24, 25 each have shoulders 26, 27 that is configured to abut the shoulders (not shown) disposed inside the first pair of telescoping members 11, 12 and thus limiting the upward travel of the second pair of telescoping members 24, 25. At the top of the second pair of telescoping members 24, 25, the outside diameters are preferably stepped down to form cylindrical tenons 28, 29 which are inserted into holes 30, 31 in the striking member 32 and then rigidly bonded by ultrasonic or chemical means.

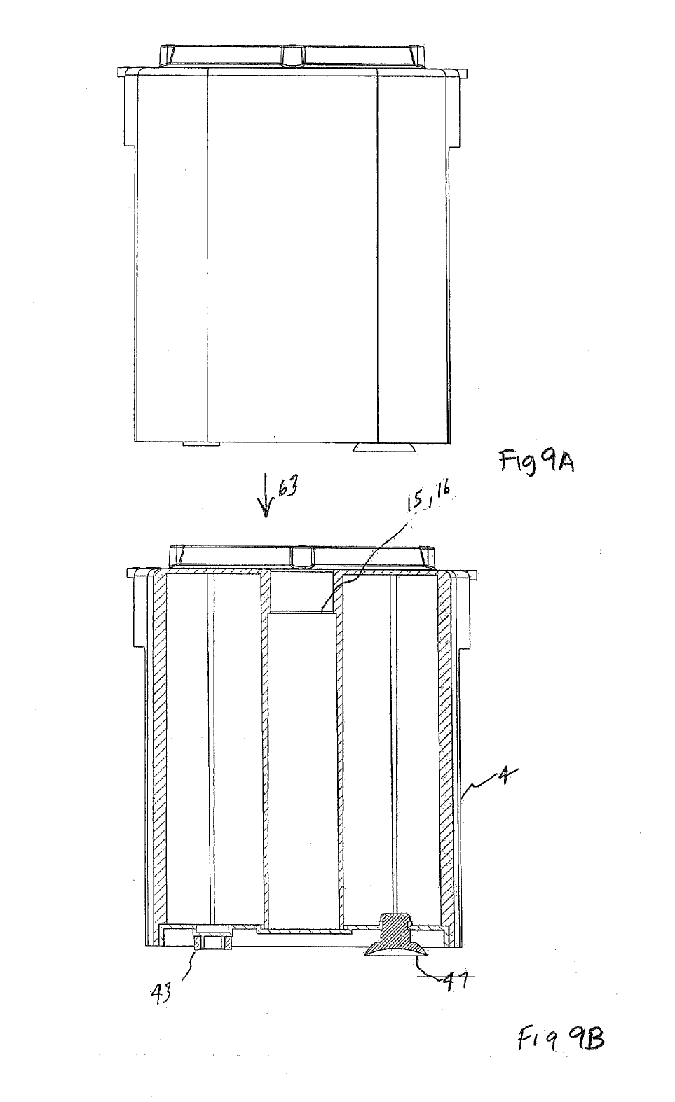

Bottom support panels 40, 41 may optionally be provided on the bottom surface of the base 4, as shown in FIGS. 3, 5, and 9A-9B. These panels may be used to provide down stops for the first pair of telescoping members 11, 12. Rubber feet 42, 43 may be snapped into holes 44, 45 disposed on the base. Additionally, suction cups 46, 47 may be snapped into holes 48, 49. The height of the suction cups 46, 47 are designed such that when the suction cups 46, 47 are compressed, rubber feet 42, 4, and suction cups 46, 47 at approximately the same height. The suction cups 46, 47 are preferably located diagonally and provide a force that supports the base 4 onto a working surface, such as a countertop. The apparatus 1 is easily released by tilting the base 4 to overcome the suction holding force.

It is to be understood that the detailed description and specific examples, while indicating preferred embodiments of the present invention, are given by way of illustration and not limitation. Many changes and modifications within the scope of the present invention may be made without departing from the spirit thereof, and the invention includes all such modifications.

What is claimed is:

1. An apparatus for cutting food items comprising:
a base supporting a plurality of blades;
a striking member movably disposed above the plurality of blades, the striking member being movable in opposing directions along an axis of travel; and
a compression member movably disposed between the plurality of blades and the striking member, the compression member also being movable along the axis of travel.

2. The apparatus of claim 1 further comprising a collection bin configured to be removably placed below the plurality of blades.

3. The apparatus of claim 1, wherein the striking member has a weight that is greater than a weight of the compression member.

4. The apparatus of claim 3, wherein the striking member comprises a weighted plate disposed within a casing.

5. The apparatus of claim 4, wherein a top surface of the casing comprises a shock absorbing material.

6. The apparatus of claim 1, wherein the compression member further comprises a pusher plate comprising a plurality of projections, the pusher plate being aligned along the axis with the plurality of blades configured to support the food item placed between the pusher plate and the plurality of blades.

7. The apparatus of claim 1, wherein the plurality of blades include a first set of parallel blades and a second set of parallel blades, the first and second set of parallel blades being rotatably positioned within the base.

8. The apparatus of claim 1, further comprising a first support member coupled to the compression member and at least partially disposed within the base to slidably move the compression member relative to the base and a second support member coupled to the striking member and at least partially disposed within first support member to slidably move the striking member relative to the compression member and the base.

9. The apparatus of claim 8, wherein the first member and second member are tubes and wherein the first member is nested within the second member and wherein upward motion of the first and second members are limited by stops.

10. An apparatus for slicing and/or dicing food items comprising:
a base comprising a top portion spaced above the ground, the top portion including an opening and being configured to support a plurality of blades in the opening;
at least one guide coupled to the base, the guide being configured to accommodate first and second telescoping members, the first telescoping member being nested within the guide, the second telescoping member being nested within the first telescoping member and the first and second telescoping member being slidably movable along an axis relative to the base;
a compression member coupled to the first telescoping member and movable to a first maximum distance away from the top portion of the base; and
a striking member coupled to the second telescoping member and movable to a second maximum distance away from the top portion of the base.

11. The apparatus of claim 10, wherein the at least one guide and the first and second telescoping members are cylindrical tubes.

12. The apparatus of claim 11, wherein the at least one guide and the first and second telescoping tubes each have abutting stops to set the first and second maximum distances.

13. The apparatus of claim 10, wherein the plurality of blades are provided by one or more blade inserts.

14. The apparatus of claim 13, wherein the one or more blade inserts are rotatably positioned relative to one another in the opening.

15. The apparatus of claim 14, wherein the blade inserts comprise tensioned blades and a die cast metal frame.

16. The apparatus of claim 15, wherein the blade inserts are positioned in the opening by mating alignment guides and tabs.

17. The apparatus of claim 10, further comprising a collection bin having an internal cavity, the collection bin being removably disposed below the top portion of the of the base and dimensioned to accommodate at least the base, compression member and the striking member within the internal cavity.

18. The apparatus of claim 10, wherein the weight of the striking member is from 0.5 to 5 lbs.

19. The apparatus of claim 10, further comprising a pair of suction cups disposed diagonally on opposing sides of the base to secure the apparatus to a surface.

20. An apparatus for cutting food items comprising:
a base comprising a top portion spaced above the ground, the top portion including an opening and being configured to support one or more blade inserts in the opening, the one or more blade inserts each comprising one or more blades;
at least one guide coupled to the base, the guide being configured to accommodate first and second telescoping members, the first telescoping member being nested within the guide, the second telescoping member being nested within the first telescoping member and the first and second telescoping member being slidably movable in a reciprocating manner along an axis relative to the base;
a compression member coupled to the first telescoping member and movable to a first maximum distance from the top portion of the base, the compression member further comprising a pusher plate to support the food item placed between the compression member and the blade inserts disposed in the opening of the top portion of the base;
a striking member having a weight sufficient to impart a concussive force on the compression member, the striking member being coupled to the second telescoping member and movable to a second maximum distance from the compression member; and
a bin removably disposed below the opening configured to receive cut food items as it exits the opening having the one or more blade inserts.
